(19) United States
(12) Patent Application Publication
(10) Pub. No.: US 2006/0233654 A1
(43) Pub. Date: Oct. 19, 2006

(54) COMPRESSOR WITH RADIAL COMPLIANCE MECHANISM

(75) Inventors: Anil Gopinathan, Clinton, MI (US); David K. Haller, Adrian, MI (US)

Correspondence Address: BAKER & DANIELS LLP;111 E. WAYNE STREET, SUITE 800, FORT WAYNE, IN, 46802, US

(73) Assignee: Tecumseh Products Company, Tecumseh, MI (US)

(21) Appl. No.: 11/278,213

(22) Filed: Mar. 31, 2006

Related U.S. Application Data
(60) Provisional application No. 60/670,105, filed on Apr. 11, 2005.

(51) Int. Cl. F01C 1/02; F01C 21/10; F16N 13/20; F04C 2/00; F04C 18/00; F03C 4/00; F01C 1/063; F03C 2/00

(52) U.S. Cl. 418/54; 418/150

(57) ABSTRACT

A radial compliance mechanism for a scroll compressor which includes a crankshaft having an eccentric with a substantially rectangular cross section in a plane normal to the longitudinal axis of the crankshaft. A substantially cylindrical roller is provided with a substantially square central opening and mounted on the eccentric. Opposite axial ends of the roller are substantially similar. The roller can be properly mounted on the eccentric with the eccentric being inserted into either end of the roller and with the roller being at any rotational orientation at which the eccentric can be inserted thereby preventing the roller from being mounted on the eccentric in an incorrect position.

### BACKGROUND OF THE INVENTION

1. Field of the Invention

The present invention relates to a radial compliance mechanism for a compressor assembly.

2. Description of the Related Art

Scroll compressors include a stationary scroll member and an orbiting scroll member, each having a spiral scroll wrap extending from a base plate. The stationary scroll member is oftentimes secured to a crankcase to secure it in a stationary position with the orbiting scroll member positioned between the stationary scroll and the crankcase. The stationary and orbiting scroll wraps are intermeshed with the tips of the scroll wraps engaging the base plate of the opposite scroll member. The spaces defined between the stationary and orbiting scroll wraps define closed compression chambers in which refrigerant is received.

During the operation of the scroll compressor, the orbiting scroll member is driven by a crankshaft causing the compression chambers to become progressively smaller as they move radially inwardly toward the centers of the stationary and orbiting scroll members, thus compressing the refrigerant located in the compression chambers. The compressed refrigerant is discharged through an outlet port.

To operate efficiently, the spiral wraps of the stationary and orbiting scrolls must effectively seal the individual compression chambers defined between the two scroll members otherwise refrigerant will migrate from relatively high pressure chambers to areas of lower pressure. One aspect of effectively sealing the compression chambers involves maintaining the seal between spiral tips and the base plate of the opposite scroll member which requires maintaining the scroll members in their desired axial positions as the scrolls move relative to each other, i.e., maintaining axial compliance. Another important aspect of effectively sealing the compression chambers involves maintaining lines of contact between the spiral wraps to separate the individual compression chambers. Maintaining the spiral wraps in sealing engagement requires maintaining the scroll members in their desired radial positions relative to each other as the scrolls move relative to each other, i.e., maintaining radial compliance.

Although various radial compliance mechanisms have been developed to control the relative radial positions of the scroll members, an improved radial compliance mechanism that is effective and easily manufactured and assembled is desirable.

### SUMMARY OF THE INVENTION

The present invention provides a radial compliance mechanism for a compressor assembly which includes a roller that cannot be mounted on the eccentric in an improper orientation.

The invention comprises, in one form thereof, a compressor assembly having an orbiting member and a stationary member that are mutually engaged. A crankshaft defines a rotational axis and includes an eccentric portion disposed asymmetrically relative to the rotational axis. The eccentric portion defines a first set of opposed, generally planar, parallel surfaces spaced apart by a first distance and a second set of opposed, generally planar, parallel surfaces spaced apart by a second distance with the first distance being greater than the second distance. The first set of eccentric surfaces are positioned substantially perpendicular to the second set of eccentric surfaces. A roller is mounted on the eccentric and operably couples the crankshaft to the orbiting member wherein rotation of the crankshaft orbits the orbiting member relative to the stationary member. The roller has an outer substantially cylindrical surface defining a roller axis. The roller defines a central opening extending axially from a first end of the roller to a second end of the roller with the opening having a first pair of opposed, inwardly facing, generally planar, parallel surfaces and a second pair of opposed, inwardly facing, generally planar, parallel surfaces. The first and second pair of roller surfaces are each spaced apart by a distance approximately equivalent to the first distance whereby the central opening defines a substantially square shape. The first and second ends of the roller have a substantially common configuration. The roller is mountable on the eccentric portion in a plurality of roller orientations including a first axial orientation wherein the first end is positioned distally of the second end and a second axial orientation wherein the second end is positioned distally of the first end.

The invention comprises, in another form thereof, a compressor assembly having an orbiting member and a stationary member that are mutually engaged. A crankshaft defines a rotational axis and including an eccentric portion disposed asymmetrically relative to the rotational axis. The eccentric portion has a substantially rectilinear cross section. A roller is mounted on the eccentric and operably couples the crankshaft to the orbiting member wherein rotation of the crankshaft orbits the orbiting member relative to the stationary member. The roller has an outer substantially cylindrical surface defining a roller axis. The roller defines a central opening extending axially from a first end of the roller to a second end of the roller with the opening defining a substantially square shape for receiving the eccentric and permitting linear sliding movement of the roller relative to the eccentric. The first and second ends of the roller have a substantially common configuration with the roller being mountable on the eccentric portion in a plurality of roller orientations including a first axial orientation wherein the first end is positioned distally of the second end and a second axial orientation wherein the second end is positioned distally of the first end. The roller is mountable in a plurality of rotational orientations in each of the first and second axial orientations.

An advantage of the present invention is that all of the orientations in which the roller can be mounted on the eccentric properly position the roller on the eccentric thereby preventing misassembly of the radial compliance mechanism.

Another advantage of the present invention is that the forces exchanged between the roller and the eccentric can be controlled by the orientation of the eccentric whereby the eccentric can be oriented in a manner that best facilitates the radial loading between the scroll wraps to provide an effective sealing engagement between the scroll wraps.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a sectional view of a scroll compressor in accordance with the present invention.

FIG. 2 is a side elevational view of the crankshaft of the scroll compressor of FIG. 1.

FIG. 3 is an alternative side elevational view of the crankshaft of the scroll compressor of FIG. 1.

FIG. 4 is a sectional view of the crankshaft of FIG. 2 taken along line 4-4.

FIG. 5 is an end view of the crankshaft of FIG. 2.

FIG. 6 is a perspective view of a roller in accordance with the present invention.

FIG. 7 is an alternative perspective view of the roller of the present invention.

FIG. 8 is an end view of the roller of FIG. 6.

FIG. 9 is a sectional view of the roller of FIG. 8 taken along line 9-9.

FIG. 10 is a fragmentary elevational view of the roller and crankshaft assembly in accordance with the present invention.

FIG. 11 is an end view of the roller and crankshaft assembly in a first position.

FIG. 12 is an end view of the roller and crankshaft assembly in a second position.

FIG. 13 is a perspective view of an alternative embodiment of the roller of the present invention.

FIG. 14 is a fragmentary perspective view of an alternative embodiment of the crankshaft of the present invention.

FIG. 15 is a fragmentary perspective view of the assembled roller of FIG. 13 and crankshaft of FIG. 14.

FIG. 16 is a schematic view of the orientation of the eccentric relative to the rotational axis of the crankshaft.

FIG. 17 is a schematic view of an alternative orientation of the eccentric relative to the rotational axis of the crankshaft.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

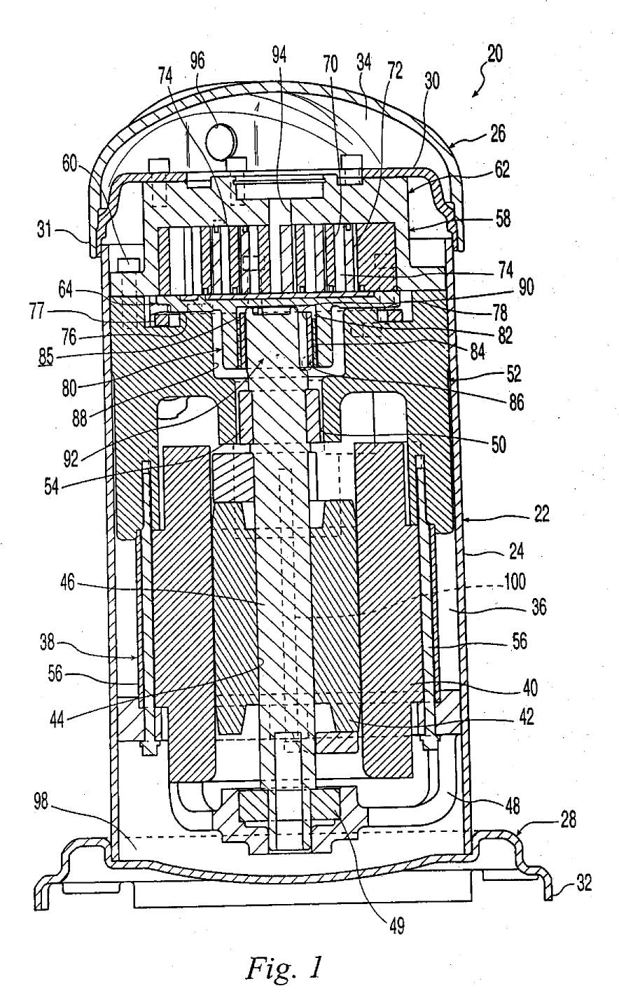

Referring to FIG. 1, there is shown hermetic compressor 20 which is a scroll type compressor. Hermetic scroll compressor 20 includes housing 22 formed from main housing portion 24, top end cap 26, and base plate 28. Separator member 30 is affixed to the upper end of main housing portion 24 with outer flange 31 being captured between the outer surface of main housing portion 24 and the inner surface of top end cap 26. Both top end cap 26 and separator member 30 are secured to the upper end of main housing portion 24 by any suitable method including welding, brazing, or the like. Base plate 28 is provided with annular support 32 for supporting compressor 20 in a substantially vertical orientation. Base plate 28 is secured to the lower end of main housing portion 24 by any suitable method including welding, brazing, or the like.

Separator member 30 divides housing 22 into discharge pressure chamber 34 and suction pressure chamber 36. Motor 38 is mounted in suction pressure chamber 36 and secured to main housing portion 24 by being interference or heat-shrink fitted therein. Other methods of securing motor 38 may also be used. Motor 38 includes stator 40 and rotor 42. Rotor 42 is provided with central aperture 44 in which crankshaft 46 is rotationally fixed to rotor 42. Crankshaft 46 may be secured to rotor 42 by heat shrink fitting or other suitable method. The lower end of crankshaft 46 is rotatably supported by bearing 49 mounted in outboard bearing support 48. Bearing support 48 is secured to the lower end of main housing portion 24 by a heat shrink interference fit in the illustrated embodiment. The upper end of crankshaft 46 is rotatably supported in aperture 50 formed in crankcase 52 by bearing 54. Crankcase 52 is fixedly mounted to stator 40 by fasteners 56 which pass through outboard bearing support 48 and stator 40 to engage crankcase 52. Compression mechanism 58 is mounted adjacent crankcase 52 by screws 60 which secure fixed scroll member 62 to crankcase 52. Rotor 42 rotates crankshaft 46 to drive compression mechanism 58 which in turn compresses refrigerant fluid.

Compressor 20 is a scroll-type compressor with compression mechanism 58 including fixed scroll member 62 and orbiting scroll member 64. Fixed scroll member 62 and orbiting scroll member 64 include base plates 66, 68, respectively, having scroll wraps 70, 72 extending therefrom. When fixed member 62 and orbiting member 64 are assembled, scroll wraps 70 and 72 intermesh such that portions of the scroll wrap sidewall surfaces or faces are in sealing contact and the distal tips of scroll wraps 70, 72 engage the base plates 68, 66 of the opposite scroll members thus creating a plurality of compression chambers 74 therebetween. Orbiting scroll member 64 is positioned between crankcase 52 and fixed scroll member 62 such that rear surface 76 of orbiting scroll member plate 68 is in contact with thrust surface 78 of crankcase 52. A conventional Oldham ring 77 is positioned between and engages both crankcase 52 and orbiting scroll member 64 to prevent the rotation of orbiting scroll member 64 as it is orbited by the rotation of crankshaft 46. Annular hub 80 extends from back surface 76 of plate 68 having cavity 82 formed therein in which bearing 84 and roller 86 are located. Hub 80, bearing 84, and roller 86 are received in cavity 88 formed in crankcase 52. Bearing 84 is in surrounding relationship of outer cylindrical surface 85 of roller 86 to rotatably support roller 86 within orbiting scroll hub 80. Roller 86 is provided with central opening 90 to receive eccentric 92 integrally formed at the end of crankshaft 46 to drivingly couple compression mechanism 58 and crankshaft 46 and provide a radial compliance mechanism as will be discussed further hereinbelow.

The operation of compressor 20 includes motor 38 being electrically energized in a conventional manner to induce rotation of rotor 42 and in turn crankshaft 46. Suction pressure refrigerant vapor is drawn into the space between the stationary and orbiting scrolls 62, 64 near their outer radial edge from suction pressure chamber 36. As crankshaft 46 rotates, orbiting scroll member 64 orbits relative to fixed scroll member 62. The orbital movement of orbiting scroll member 64 causes compression chambers 74 defined between the two scroll members to migrate radially inwardly and become smaller thereby compressing the refrigerant to a higher pressure. The refrigerant is exhausted from compression mechanism 58 at a discharge pressure through port 94 formed in base plate 66 of fixed scroll member 62. The discharge pressure refrigerant enters discharge chamber 34 defined by end cap 26 and exits compressor 20 through discharge outlet 96. After discharge through outlet 96 the compressed refrigerant may be circulated through an air conditioning, refrigeration, heat pump or other system utilizing a compressed vapor. The refrigerant is returned to compressor 20 at a relatively lower suction pressure and enters suction pressure chamber 36 through an inlet port in housing 22 (not shown).

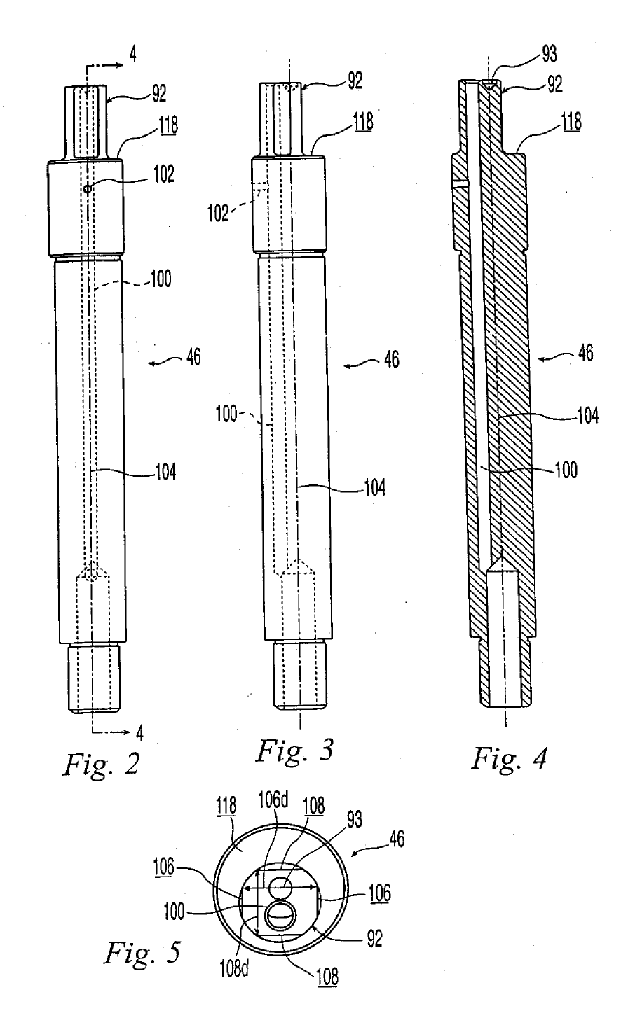

During compressor operation, oil from oil sump 98 located in the lower portion of housing 22 is drawn upwardly through crankshaft 46 and distributed to bearing surfaces for lubrication thereof. Referring to FIGS. 2, 3, and 4, an oil passageway 100 that extends the longitudinal length of crankshaft 46 is formed by boring two intersecting bore holes from opposite ends of crankshaft 46. The lower end of crankshaft 46 is positioned proximate sump 98 and a conventional oil pump assembly (not shown) pumps lubricating oil upwardly into passageway 100. As the oil is forced upwardly within oil passageway 100, the rotation of crankshaft 46 discharges oil radially outwardly by centrifugal force through radial passage 102 to lubricate bearing 54. A portion of the oil travels the length of crankshaft 46 and exits passageway 100 at the distal end of eccentric 92 to lubricate bearing 84 and roller 86.

While a specific scroll compressor 20 has been disclosed to illustrate the use of the radial compliance mechanism formed by eccentric 92 and roller 86, alternative compressor designs may also be used with the present invention. For example, the compressor could be horizontally oriented instead of vertically oriented as illustrated. The present invention might also be used with compressor mechanisms other than scroll mechanisms which employ an orbiting member.

Referring to FIGS. 2-5, eccentric 92 is integrally formed at one end of crankshaft 46 and is offset from rotational axis 104 of crankshaft 46. Referring to FIG. 5, eccentric portion 92 is manufactured by first forming a cylindrical projection and then machining four planar surfaces on the cylindrical projection to provide eccentric 92 with a substantially rectangular cross section with rounded comers in a plane normal to the rotational axis 104 of crankshaft 46. Eccentric portion 92 includes a first set of opposed, generally planar, parallel surfaces 106 which are spaced apart by a first distance 106d. A second set of opposed, generally planar, parallel surfaces 108 are substantially perpendicular to the first set of surfaces and are spaced apart by a second distance 108d such that first distance 106d is greater than second distance 108d. Conical depression 93 is located on the rotational axis of crankshaft 46 and is used to properly locate shaft 46 during manufacturing operations.

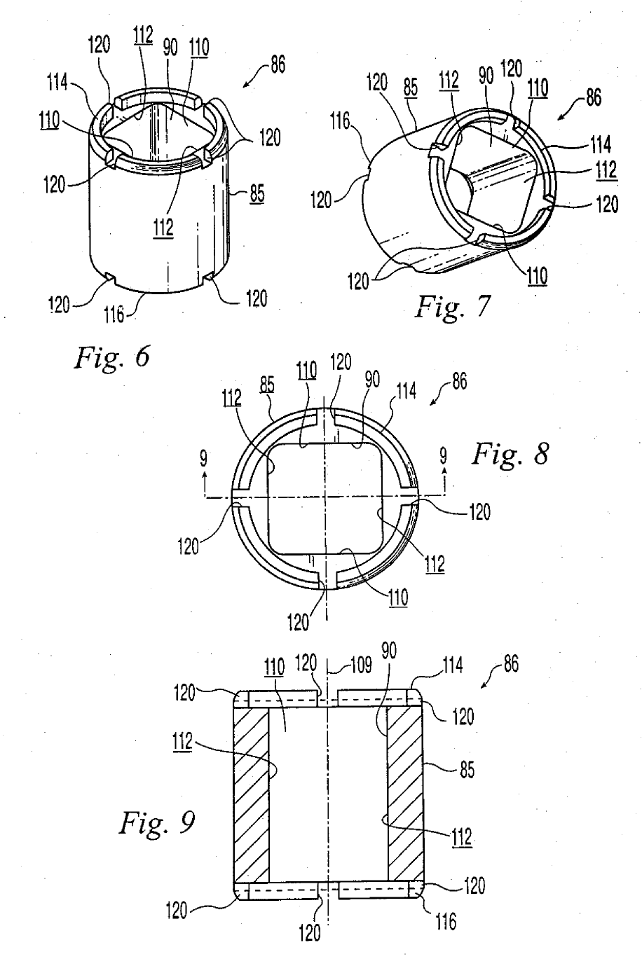

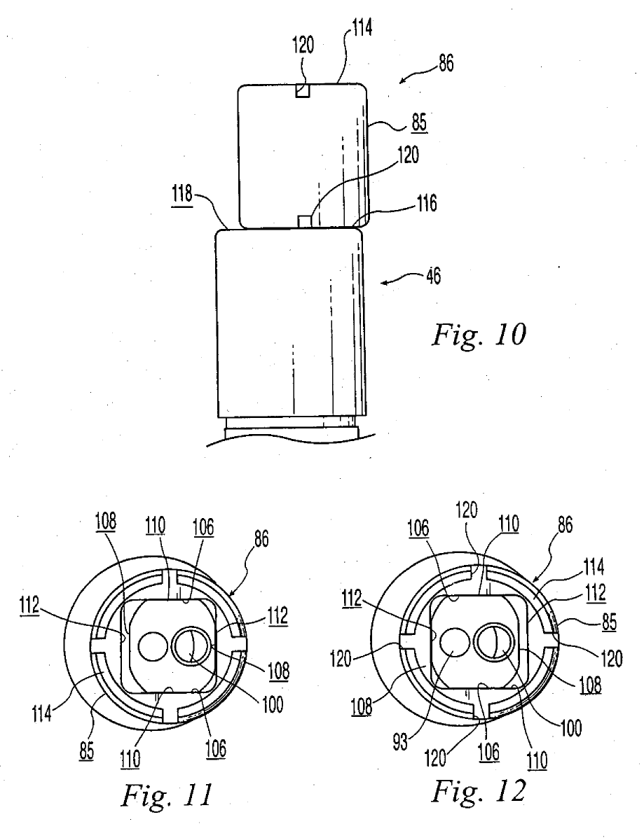

Roller 86, best seen in FIGS. 6-9, is substantially cylindrical and has an outer cylindrical surface 85 defining longitudinal axis 109 and a central opening 90 extending the axial length of roller 86. Central opening 90 includes a first pair of opposed, generally planar, parallel surfaces 110 and a second pair of opposed, generally planar, parallel surfaces 112. Each pair of surfaces 110 and 112 are positioned apart by a substantially equivalent distance to create a substantially square central opening 90. The distance separating each pair of surfaces 110 and 112 is substantially equivalent to the distance separating first eccentric surfaces 106 on eccentric 92 and sized to allow roller 86 to be mounted on eccentric 92.

As can be seen in FIGS. 10-12, roller 86 is mounted on eccentric 92 such that first opposed, parallel eccentric surfaces 106 are in sliding engagement with interior surfaces of central opening 90. In the exemplary illustrations, roller 86 is mounted on eccentric 92 with first eccentric surfaces 106 in contact with first roller surfaces 110, however, because roller surfaces 110 and roller surfaces 112 are spaced apart by a common distance and define a substantially square opening, roller 86 may be rotated by 90°, or other odd multiple of 90°, when mounting roller 86 to eccentric 92 to place surfaces 112 in sliding contact with surfaces 106 of eccentric 92. Roller 86 has opposed axial ends 114 and 116 which have substantially similar configurations to enable roller 86 to be mounted on eccentric 92 with either first end 114 or second end 116 being placed in contact with surface 118 of crankshaft 46. Because of this symmetry, roller 86 can be mounted to eccentric 92 by inserting eccentric 92 through opening 90 of either end 114 or 116 of roller 86 and in any of the potential rotational orientations at which eccentric 92 will fit within opening 90 and roller 86 will be properly positioned on eccentric 92 thereby facilitating the manufacture of the compressor and preventing roller 86 from being mounted on eccentric 92 in an improper alignment.

Referring to FIGS. 6-12, a first embodiment of roller 86 is illustrated. Roller 86 is provided with radially extending recesses 120 at first and second ends 114 and 116. Recesses 120 define oil passageways for allowing the passage of oil from oil passageway 100 radially outwardly. In the illustrated embodiment, most of the oil discharged from passageway 100 will flow downwardly within opening 90 toward surface 118 and then radially outwardly through recesses 120. Some of the oil discharged from passageway 100 may also flow radially outwardly through recesses 120 located at the distal end of roller 86, i.e., at first end 114 in FIG. 10. The oil flowing radially outwardly through recesses 120 may then lubricate bearings 84 and 54.

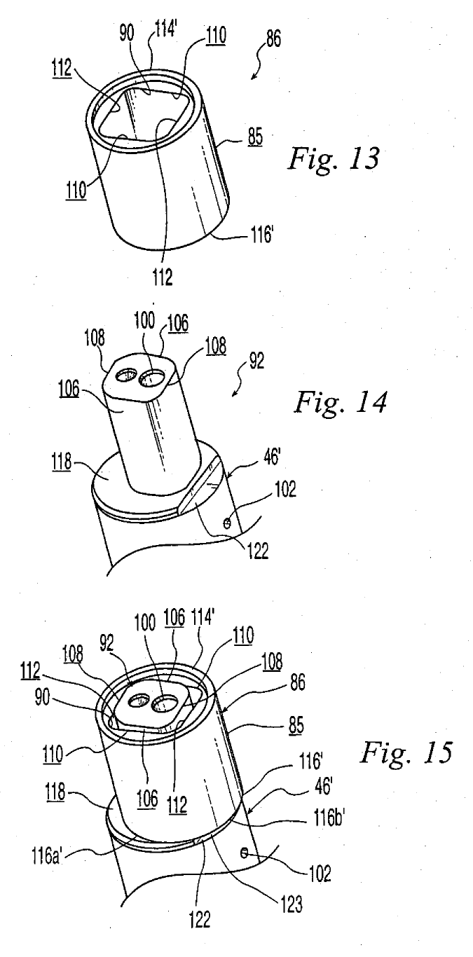

A second embodiment of the roller and crankshaft are shown in FIGS. 13-15, i.e., roller 86′ and crankshaft 46′. First and second ends 114′ and 116′ of roller 86′ are annular and do not includes recesses for oil passage. Rather, crankshaft 46′ (FIG. 14) is provided with cutout portion 122 located in axial end surface 118 of the crankshaft from which eccentric 92 extends. As best seen in FIG. 15, a portion 116a′ of end 116′ of roller 86′ is in contact with surface 118 while the remaining portion 116b′ of end 116′ is positioned above cutout portion 122 to form a gap 123. Gap 123 formed between an end of the roller 86′, which may be either end 116′ or 114′, and crankshaft 46 allows oil to flow radially outwardly from opening 90. In addition to flowing radially outwardly through gap 123, oil may also flow radially outwardly at the opposite end of roller 86′, which is end 114′ in FIG. 15, within hub 80 to lubricate bearing 84. Apart from ends 114′ and 116′ of roller 86′ and cutout portion 122 on crankshaft 46′, roller 86′ and crankshaft 46′ are similar to roller 86 and crankshaft 46.

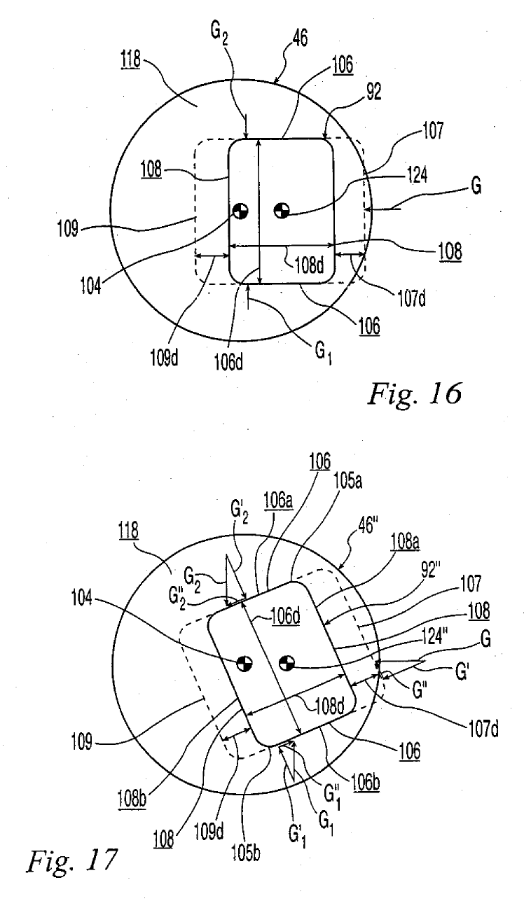

The operation of the radial compliance mechanism formed by roller 86 and crankshaft 46 will now be described with reference to FIG. 16. Another embodiment of the crankshaft is illustrated in FIG. 17 wherein crankshaft 46″ has an eccentric 92″ that is positioned at a different orientation than that of FIG. 16. In each of FIGS. 16 and 17, the eccentric 92, 92″ is schematically illustrated with the differences between distances 106d and 108d being exaggerated to more clearly illustrate the interaction of the eccentric with a roller mounted thereon. In each of FIGS. 16 and 17, the rotational axis of the crankshaft 46, 46″ is at location 104 with the centroid of the eccentric 92, 92″ being positioned at location 124, 124″ respectively. As described above, the centroid 124, 124″ is the point which is midway between surfaces 106 and also midway between surfaces 108.

Turning first to the embodiment represented in FIG. 16, first eccentric surfaces 106 are substantially parallel to a plane that intersects both centroid 124 and rotational axis 104 while surfaces 108 are oriented substantially perpendicular to a plane intersecting both rotational axis 104 and centroid 124. When a roller, e.g., roller 86 or 86′, having a substantially square central opening 90 and with the distance separating the opposed surfaces of the central opening being substantially equal to distance 106d is mounted on eccentric 92, the roller will be capable of moving in a direction parallel to surfaces 106. Dashed line 107 represents one edge of the central opening when the roller is moved radially outwardly with respect to axis 104 and the opposite edge of the central opening has engaged the eccentric surface 108 proximate axis 104. When opening 90 is square and closely fits surfaces 106, the distance 107d will be substantially equivalent to the difference between distances 106d and 108d. Similarly, dashed line 109 represents an edge of the central opening 90 when the roller 86 is moved radially inwardly until the opposite surface of central opening 90 engages the radially outer eccentric surface 108. Distance 109d is substantially equivalent to distance 107d. Thus, roller 86 can travel a distance equal to the sum of both 107d and 109d in a radial direction. In the illustrated embodiments distance 106d is between 0.618 and 0.620 inches (15.70 and 15.75 mm), distance 108d is between 0.565 and 0.575 inches (14.35 and 14.60 mm) and the distance separating opposed surfaces of central opening 90 is between 0.624 and 0.626 inches (15.85 and 15.90 mm) whereby surfaces 106 slidingly engage a set of opposed surfaces of central opening 90.

As crankshaft 46 rotates, compressed refrigerant gas between the scroll wraps exerts forces on the spiral wraps which if crankshafts 46, 46″ are rotated in a clockwise direction results in forces on the roller that has a first force component G that is directed radially inwardly along the line connecting axis 104 and centroid 124, 124″ and a second force component that is directed perpendicular to a line connecting axis 104 and centroid 124, 124″. If crankshafts 46, 46″ were rotated clockwise, the second force component would be oriented as shown by G1 and if crankshafts 46, 46″ were rotated counterclockwise, the second force component would be oriented as shown by G2.

With regard to the embodiment shown in FIG. 16, the centrifugal forces acting on roller 86 will urge roller 86 in a radially outward direction relative to axis 104 in direct opposition to force G. This in turn will also urge orbiting scroll member 64 in a radial outer direction relative to axis 104. Orbiting scroll member 64 and stationary scroll member 62 have spiral wraps of a conventional design and biasing the wraps of orbiting scroll 64 radially outward will urge the spiral wrap of the orbiting scroll 64 into engagement with the spiral wrap of the stationary scroll 62 to facilitate a sealing engagement between the two spiral wraps. Moreover, by providing for the limited radial travel of orbiting scroll 64, the manufacture and assembly of the compressor is facilitated by allowing the radial position of orbiting scroll to vary relatively broadly with respect the position of surfaces 108 on eccentric 92. Furthermore, relative radial movement of orbiting scroll 64 relative to axis 104 during operation of the compressor may also facilitate the maintenance of a tight seal between spiral wraps 70, 72 in the presence of slight inconsistencies in the machining of the spiral wraps 70, 72. Thus, the interaction between eccentric 92 and roller 86 provides a radial compliance mechanism for the compressor. With regard to the second force component, i.e., either G1 or G2 depending on the direction of rotation, this force will directly bear against one of the flank surfaces 106 of eccentric 92.

The embodiment shown in FIG. 17 provides a radial compliance mechanism that functions in a manner generally similar to that described above with respect to the embodiment of FIG. 16. The embodiment of FIG. 17, however, has first eccentric surfaces 108 that are positioned at a non-perpendicular angle to the plane that intersects both centroid 124 and rotational axis 104. In the exemplary embodiment, surfaces 106 are at a 6.7° angle to the plane connecting centroid 124 and axis 104 and, thus, surfaces 108 are at a 96.7° angle to this same plane. In the embodiment of FIG. 17, when the compressor operates, the roller still experiences the same loads G and either G₁, if crankshaft 46″ is rotated clockwise, or G₂, if crankshaft 46″ is rotated counterclockwise, as the embodiment of FIG. 16. When crankshaft 46″ is rotated clockwise, as it would be when shaft 46″ is used in compressor 20, corner 105b between surfaces 106b and 108b forms a leading edge with surface 106b being positioned radially outward of surface 108b. In this situation, forces G and G₁ are applied to eccentric 92″ by the roller. Force G has a component G′ that is parallel to sliding surfaces 106 and which is countered, at least in part, by centrifugal forces acting on the roller and a component G″ that is normal to 106b and which therefore applies a load to surface 106b. Force G₁ also includes a component G₁″ that is normal to surface 106b and applies a load to surface 106b. Force G₁ further includes a component that is parallel to surface 106b in the opposite direction of force G′ and thereby, together with the centrifugal forces acting on the roller, helps to counteract force G′ to maintain spiral wraps 70, 72 in contact.

If the embodiment of FIG. 17 is rotated in the counterclockwise direction, the forces acting on eccentric 92″ would be G and G₂. In this case, surfaces 106a and 108a define leading edge 105a wherein surface 108a is positioned radially outward of surface 106a. Once again force G has a component G′ that is parallel to sliding surfaces 106 and directed radially inwardly and a component G″ that is normal to 106b. Force G₂ has a component G₂′ that is normal to surface 106a and in a direction opposite to force G″ whereby if G₂′ is greater than G″ a force will be applied to surface 106a and if G″ is greater, a force will be applied to surface 106b. Force component G₂″ is parallel to sliding surfaces 106 and directed radially inwardly whereby forces G₂″ and G′ are both directed in the same direction and both must be countered by centrifugal forces acting on the roller. For many compressor designs this additive nature of forces G₂″ and G′ would not be desirable and if crankshaft 46″ were to be rotated in a counterclockwise direction, eccentric 92″ would be repositioned so that a sliding surface 106 against which the roller continuously bears is the more radially outward surface of the two surfaces forming the leading edge of the eccentric. For other compressor designs, however, the it might be desirable to add forces G₂″ and G′. For example, while it is desirable for the radial compliance mechanism to bias the spiral wraps of the orbiting and stationary scroll members into engagement, in some situations such biasing forces and the resulting friction could become excessive.

By adjusting the orientation of eccentric 92″ relative to rotational axis 104, the effective total forces acting on the roller can be varied to facilitate the effective operation of the compressor in which the shaft and roller are employed.

While this invention has been described as having an exemplary design, the present invention may be further modified within the spirit and scope of this disclosure. This application is therefore intended to cover any variations, uses, or adaptations of the invention using its general principles.

What is claimed is:

1. A compressor assembly comprising:
an orbiting member and a stationary member, said members being mutually engaged;
a crankshaft defining a rotational axis and including an eccentric portion disposed asymmetrically relative to said rotational axis, said eccentric portion defining a first set of opposed, generally planar, parallel surfaces spaced apart by a first distance and a second set of opposed, generally planar, parallel surfaces spaced apart by a second distance, said first distance being greater than said second distance, said first set of eccentric surfaces being positioned substantially perpendicular to said second set of eccentric surfaces;
a roller mounted on said eccentric and operably coupling said crankshaft to said orbiting member wherein rotation of said crankshaft orbits said orbiting member relative to said stationary member; said roller having an outer substantially cylindrical surface defining a roller axis, said roller defining a central opening extending axially from a first end of said roller to a second end of said roller, said opening having a first pair of opposed, inwardly facing, generally planar, parallel surfaces and a second pair of opposed, inwardly facing, generally planar, parallel surfaces, said first and second pair of roller surfaces each being spaced apart by a distance approximately equivalent to said first distance whereby said central opening defines a substantially square shape, said first and second ends of said roller having a substantially common configuration and wherein said roller is mountable on said eccentric portion in a plurality of roller orientations, said orientations including a first axial orientation wherein said first end is positioned distally of said second end and a second axial orientation wherein said second end is positioned distally of said first end.

2. The compressor assembly of claim 1 wherein said plurality of roller orientations includes a first rotational orientation wherein said first pair of roller surfaces are positioned to slidingly engage said first set of eccentric surfaces and a second rotational orientation wherein said second pair of roller surfaces are positioned to slidingly engage said first set of eccentric surfaces.

3. The compressor assembly of claim 1 wherein said roller further comprises at least one radially extending recess located on each of said first and second ends of said roller, said recesses defining an oil passageway between said central opening and said outer cylindrical surface.

4. The compressor assembly of claim 1 wherein said crankshaft has a first end surface, said eccentric portion projecting from said first end surface parallel to said rotational axis, mounting of said roller on said eccentric engaging a first portion of one of said roller ends with said first end surface and wherein said first end surface is configured to define a gap between a second portion of said one of said roller ends extending radially from said central opening to said outer cylindrical surface of said roller and thereby defining an oil passageway.

5. The compressor assembly of claim 1 wherein said first end surface is a substantially planar surface oriented perpendicular to said rotational axis and includes a recess for defining said gap.

6. The compressor of claim 1 wherein said eccentric portion defines a centroid located midway between said first set of eccentric surfaces and midway between said second set of eccentric surfaces and wherein said first set of eccentric surfaces are positioned substantially parallel to a plane intersecting both said centroid and said rotational axis.

7. The compressor of claim 1 wherein said eccentric portion defines a centroid located midway between said first set of eccentric surfaces and midway between said second set of eccentric surfaces and wherein said first set of eccentric surfaces are positioned at a non-perpendicular angle to a plane intersecting both said centroid and said rotational axis.

8. The compressor of claim 7 wherein a first one of said first set of eccentric surfaces and a first one of said second set of eccentric surfaces define a leading edge of said eccentric portion relative to the rotational direction of said crankshaft and wherein said first one of said first set of surfaces is positioned radially outwardly of said first one of said second set of surfaces.

9. The compressor of claim 7 wherein a first one of said first set of eccentric surfaces and a first one of said second set of eccentric surfaces define a leading edge of said eccentric portion relative to the rotational direction of said crankshaft and wherein said first one of said first set of surfaces is positioned radially inwardly of said first one of said second set of surfaces.

10. The compressor assembly of claim 1 wherein said compressor assembly is a scroll compressor assembly further comprising a bearing positioned between said outer cylindrical surface of said roller and said orbiting member facilitating relative rotational movement between said roller and said orbiting member.

11. The scroll compressor assembly of claim 10 further comprising an anti-rotational device to prevent rotational movement of said orbiting member relative to said stationary member as said orbiting member is orbited relative to said stationary member.

12. A compressor assembly comprising:
an orbiting member and a stationary member, said members being mutually engaged;
a crankshaft defining a rotational axis and including an eccentric portion disposed asymmetrically relative to said rotational axis, said eccentric portion having a substantially rectilinear cross section;
a roller mounted on said eccentric and operably coupling said crankshaft to said orbiting member wherein rotation of said crankshaft orbits said orbiting member relative to said stationary member; said roller having an outer substantially cylindrical surface defining a roller axis, said roller defining a central opening extending axially from a first end of said roller to a second end of said roller, said opening defining a substantially square shape for receiving said eccentric and permitting linear sliding movement of said roller relative to said eccentric, said first and second ends of said roller having a substantially common configuration and wherein said roller is mountable on said eccentric portion in a plurality of roller orientations, said orientations including a first axial orientation wherein said first end is positioned distally of said second end and a second axial orientation wherein said second end is positioned distally of said first end, said roller being mountable in a plurality of rotational orientations in each of said first and second axial orientations.

13. The compressor assembly of claim 12 wherein said plurality of rotational orientations include a first rotational orientation and a second rotational orientation offset from said first rotational orientation by 90 degrees.

14. The compressor assembly of claim 12 wherein said roller further comprises at least one radially extending recess located on each of said first and second ends of said roller, said recesses defining an oil passageway between said central opening and said outer cylindrical surface.

15. The compressor assembly of claim 12 wherein said crankshaft has a first end surface, said eccentric portion projecting from said first end surface parallel to said rotational axis, mounting of said roller on said eccentric engaging a first portion of one of said roller ends with said first end surface and wherein said first end surface is configured to define a gap between a second portion of said one of said roller ends extending radially from said central opening to said outer cylindrical surface of said roller and thereby defining an oil passageway.

16. The compressor assembly of claim 12 wherein said first end surface is a substantially planar surface oriented perpendicular to said rotational axis and includes a recess for defining said gap.

17. The compressor of claim 12 wherein said eccentric portion defines a centroid located midway between a first set of opposed outer eccentric surfaces and midway between a second set of opposed outer eccentric surfaces, said first set of surfaces being separated by a first distance and said second set of surfaces being separated by a second distance, said first distance being greater than said second distance and wherein said first set of eccentric surfaces are positioned substantially parallel to a plane intersecting both said centroid and said rotational axis.

18. The compressor of claim 12 wherein said eccentric portion defines a centroid located midway between a first set of opposed outer eccentric surfaces and midway between a second set of opposed outer eccentric surfaces, said first set of surfaces being separated by a first distance and said second set of surfaces being separated by a second distance, said first distance being greater than said second distance and wherein said first set of eccentric surfaces are positioned at a non-perpendicular angle to a plane intersecting both said centroid and said rotational axis.

19. The compressor of claim 18 wherein a first one of said first set of eccentric surfaces and a first one of said second set of eccentric surfaces define a leading edge of said eccentric portion relative to the rotational direction of said crankshaft and wherein said first one of said first set of surfaces is positioned radially outwardly of said first one of said second set of surfaces.

20. The compressor of claim 18 wherein a first one of said first set of eccentric surfaces and a first one of said second set of eccentric surfaces define a leading edge of said eccentric portion relative to the rotational direction of said crankshaft and wherein said first one of said first set of surfaces is positioned radially inwardly of said first one of said second set of surfaces.
